(19) United States
(12) Patent Application Publication
(10) Pub. No.: US 2010/0092056 A1
(43) Pub. Date: Apr. 15, 2010

(54) Mri systems and realated methods

(75) Inventors: Neil M. Rofsky, Brookline, MA (US); Daniel K. Sodickson, Larchmont, NY (US)

Correspondence Address: WOLF GREENFIELD & SACKS, P.C., 600 ATLANTIC AVENUE, BOSTON, MA, 02210-2206, US

(73) Assignee: Beth Israel Deaconess Medical Center, Inc.

(21) Appl. No.: 11/919,523

(22) PCT Filed: May 1, 2006
(86) PCT No.: PCT/US06/16752

§ 371 Date: Dec. 22, 2009

Related U.S. Application Data
(60) Provisional application No. 60/676,643, filed on Apr. 29, 2005.

(51) Int. Cl. G06K 9/60

(52) U.S. Cl. 382/131

(57) ABSTRACT

An MRI system is provided that includes a goal-oriented input interface and a result-oriented output interface. A method is provided for operating an apparatus for generating a magnetic resonance image. The method includes receiving goal-oriented input, acquiring volumetric magnetic resonance data based on the goal-oriented input, and providing result-oriented output of the acquired volumetric data. An apparatus is provided for generating a magnetic resonance image. The apparatus includes a plurality of RF receiving coils, a controller configured to receive signals from the RF receiving coils to acquire volumetric magnetic resonance data based on at least one goal-oriented input, and a user interface configured to receive goal-oriented input and provide result-oriented output indicative of the acquired volumetric data. The apparatus and methods provided can simplify the use of MRI systems via rapid comprehensive volumetric imaging.

### RELATED APPLICATIONS

This application claims priority under 35 U.S.C. § 119(e) to U.S. Provisional Application Ser. No. 60/676,643, filed on Apr. 29, 2005, which is incorporated herein by reference in its entirety.

### BACKGROUND OF THE INVENTION

1. Field of the Invention

The invention is drawn generally towards MRI systems and related methods, and more specifically to accelerated MRI systems, methods, and user interfaces. Specifically, the methods and systems of the invention include parallel MRI systems able to rapidly acquire comprehensive volumetric data.

2. Discussion of Related Art

Magnetic Resonance Imaging (MRI) has unique soft tissue contrast mechanisms, making it a very useful technology for the detection and characterization of disease. However, the acquisition of images using MRI can be complex. Despite high levels of required training for MRI operators, MR image acquisition is often plagued by errors. Such errors can arise partly from the many degrees of freedom that are set by the operator, such as the pulse sequence, target contrast, and image plane selection. Errors may also arise as a result of basic limits of MR imaging speed. An example of a typical error can include inadvertent omission of anatomy resulting from the incomplete prescription of tailored anatomic coverage and/or from patient movement between scout imaging and-diagnostic imaging. Other typical errors can include aliasing artifacts, diminished effective image contrast (e.g., resulting from attempts to reduce scan time), and incomplete scanning of patients unable to comply with long examination times.

### SUMMARY OF THE INVENTION

Accelerated MRI systems, methods, and goal-oriented user interfaces are described herein.

In one embodiment, a method is provided for operating an apparatus for generating a magnetic resonance image. The method comprises receiving at least one goal-oriented input, acquiring volumetric data indicative of a magnetic resonance response in a test subject based on the at least one goal-oriented input, and providing at least one result-oriented output indicative of the acquired volumetric data.

In a farther embodiment, an apparatus is provided for generating a magnetic resonance image. The apparatus comprises at least one RF receiving coil, a controller configured to receive signals from the at least one RF receiving coil to acquire volumetric data indicative of a magnetic resonance response in a test subject based on at least one goal-oriented input, and a user interface configured to receive the at least one goal-oriented input and provide at least one result-oriented output indicative of the acquired volumetric data.

In one embodiment, a user interface is provided for an apparatus for generating a magnetic resonance image. The user interface comprises a goal-oriented input interface and a result-oriented output interface.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single reference character or notation.

For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF DRAWINGS

FIG. 1 illustrates a magnetic resonance imaging apparatus;

FIG. 2 illustrates a multiple receiver coil array that can be used in a magnetic resonance imaging apparatus;

FIG. 3 shows a targeted volume slab approach for acquiring magnetic resonance data;

FIG. 4 shows a comprehensive volume approach for acquiring magnetic resonance data;

FIG. 5 illustrates a schematic showing a transformation between inputted diagnostic goals and parameters used for controlling an MRI apparatus;

FIG. 6 illustrates a simplified user interface for an MRI apparatus;

FIG. 7 illustrates an illustrative embodiment of simplified user interface for an MRI apparatus;

FIG. 8 illustrates a flowchart of a method for use with a simplified MRI apparatus user interface;

FIG. 9 shows a flowchart of a method for determining suitable parameter specifications based on the inputted diagnostic goals; and

FIG. 10 shows a flowchart of a method for performing an examination time restriction compatibility analysis.

### DETAILED DESCRIPTION

A Magnetic Resonance (MR) imaging apparatus including numerous receiver channels and dense coil arrays allows for rapid dynamic and comprehensive anatomic coverage is provided. This, in turn, can enable markedly simplified procedures for image prescription, and a user interface that may be streamlined as compared to user interfaces available in conventional MR imaging devices. In other embodiments presented herein, highly accelerated, comprehensive volume MR acquisitions are obtained using a simplified acquisition strategy similar to that employed in computed tomography (CT) scanning. That is, one can prescribe a large number of thin cross-section images, with little if any tailoring to a test subject's anatomy. In other embodiments presented herein, a simplified interface streamlines the number of user selections to a fraction of what is currently selected in conventional MR imaging. In some embodiments, the user simply specifies goal-oriented inputs, which may include the desired anatomic coverage, the desired resolution (e.g., low, moderate, high), and the desired contrast mechanism (e.g., T1- or T2-weighted). Alternatively, or additionally, the user may specify a desired target goal (e.g., tissue type, lesion type, etc.), which can be converted into contrast mechanisms that are suitable for observation of the desired target goal.

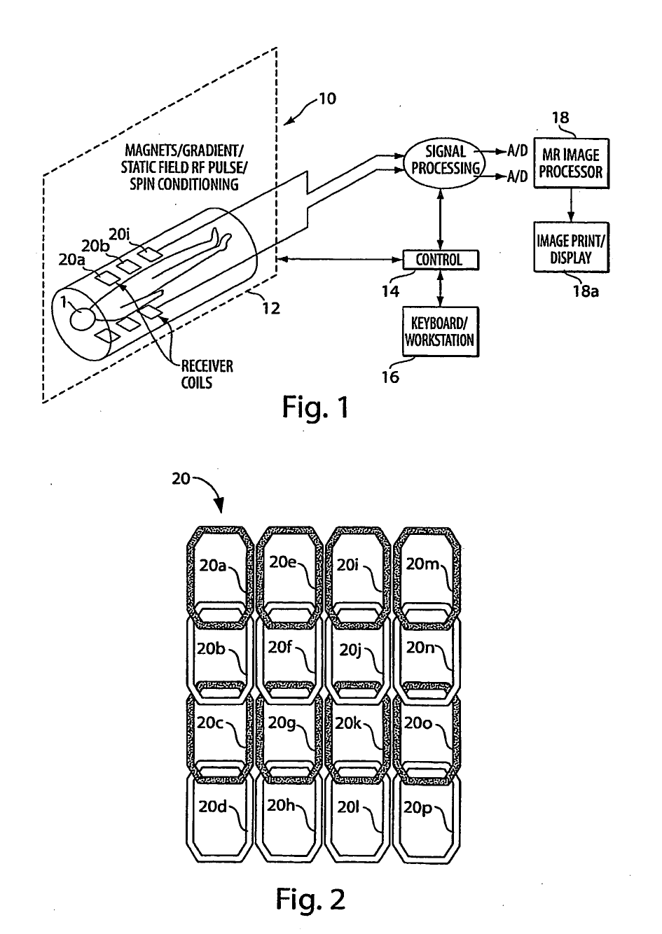

FIG. 1 illustrates schematically an MRI system 10 which includes a static magnet assembly, gradient coils, and transmit RF coils, collectively denoted 12, under control of a processor 14, which is controlled by an operator via a keyboard/control workstation 16. These devices generally employ a system of multiple processors for carrying out specialized timing and other functions in the MRI system 10 as will be appreciated. MRI system 10 includes executable computer programs that respond to user inputs from keyboard/workstation 16 to operate the system. Accordingly, as depicted in FIG. 1, an MRI image processor 18 receives digitized data representing magnetic resonance responses from an object region under examination (e.g., a human body 1) and, typically via multiple Fourier transformation processes well-known in the art, calculates a digitized visual image (e.g., a two-dimensional array of picture elements or pixels, each of which may have different gradations of gray values or color values, or the like) which is then conventionally displayed, or printed out, on a display 18a. A plurality of surface receiver coils 20a, 20b . . . 20i may be provided to simultaneously acquire MR signals for simultaneous signal reception, along with corresponding signal processing and digitizing channels.

In certain embodiments, advanced processing techniques can be used to enhance the robustness, efficiency, and quality of acquired parallel signals. Suitable processing techniques and associated MRI systems enabling parallel MR imaging have been described in, for example, U.S. Pat. No. 6,717,406, entitled “Parallel Magnetic Resonance Imaging Techniques using Radiofrequency Coil Array,” U.S. Pat. No. 6,289,232, entitled “Coil Array Autocalibration MR Imaging,” and U.S. Pat. No. 5,910,728, entitled “Simultaneous Acquisition of Spatial Harmonics (SMASH): Ultra-fast Imaging with Radiofrequency Coil Arrays,” which are incorporated herein by reference in their entirety.

Parallel MRI systems may include multiple receiver coils and parallel processing channels that process signals from each receiver coil. Parallel MRI systems can enable accelerated scanning, and the can alleviate limits on imaging speed imposed by conventional MRI systems. Specifically, parallel MRI systems can utilize the sensitivity patterns of arrays of radiofrequency receiver coils to encode spatial information in a manner complementary to encoding with magnetic field gradients.

FIG. 2 illustrates a receiver coil array that may be used in an MRI system to achieve rapid parallel MR imaging. Such receiver coil arrays can enable parallel MR imaging when associated with parallel receiver channel processors. In the illustrative receiver coil array 20 of FIG. 2, multiple receiver coils 20a, 20b . . . 20p are arranged in a four-by-four matrix configuration, but it should be appreciated that any configuration of coils is possible, as the embodiments are not limited in this respect. Furthermore, any other number of coils are possible. In some embodiments, a receiver coil array may have greater than 10 receiver coils, greater than 20 receiver coils, greater than 30 receiver coils, greater than 60 receiver coils, or greater than 100 receiver coils.

In one embodiment, a 32-element coil array is associated with a supporting 32-receiver imaging system capable of receiving simultaneous data from all 32 array elements. The 32 loop-coil elements may be etched onto two separated clamshell portions, each including 16 coils arranged in a four by four grid. The individual coils may have a suitable size and intercoil spacing. Coil sizes may be chosen to optimize the signal-to-noise ratios (SNR) for accelerated imaging. For example, the coil size may be 10.5 cm by 8.1 cm and the intercoil spacing may have an overlap of 1.8 cm along a first direction and a 1.4 cm overlap along a second direction perpendicular to the first direction.

In general, a parallel MRI system includes multiple coils, multiple receivers and data pipelines, and at least one reconstruction processor. In some embodiments presented herein, a parallel MRI system includes integrated sets of MR system electronics associated with each receiver coil, including analog-to-digital converters and digital data pipelines, which may be combined into a single clinical scanner. The receivers can be frequency and trigger locked to each other, and gradient and RF pulse sequences may be adapted to make use of the synchronization. Such configurations are illustrative embodiments of MRI systems that can enable rapid, comprehensive volume MR imaging having accelerated imaging rates as compared to previous MRI systems, but it should be understood that other configurations may be used, alternatively or additionally, to enable rapid MR imaging, as the embodiments herein are not limited in this respect.

In contrast to the aforementioned parallel MRI systems, previous MRI systems having slower imaging rates may be limited in that image data may not be readily acquired over comprehensive volumes of the test subject while maintaining a tolerable examination time. It should be appreciated that although MRI, like multi-detector X-ray Computed Tomography (CT), is a volumetric imaging modality, the use of magnetic field gradients for spatial encoding in MRI allows for a free prescription of the orientation of acquired image planes or volumes. However, spatial encoding places practical constraints on the extent of volumetric coverage achievable for a desired spatial resolution in MRI examinations. In the wake of RF pulses that excite magnetization in the imaged region, field gradients of varying amplitude, direction, and/or duration are applied and signal data are acquired in sequential readouts. However, the maximum rate of gradient switching is limited by the inductance of gradient coils and by the need to avoid neuromuscular stimulation from currents induced by the rapidly changing fields. Safety considerations for tissue heating also limit the rate of application of RF pulses. These physical and physiologic constraints on gradient switching rate and RF power deposition limit the rate at which MR imaging sequences may be executed, and consequently, the rate at which image data may be acquired in traditional MR systems. Meanwhile, the allowable temporal window for data acquisition is generally limited by a number of factors, including the feasible breath-hold duration in abdominal and thoracic imaging, by the passage of contrast agents in vascular studies, by the dynamics of cardiac and respiratory motion in cardiac MRI, and/or by patient comfort and compliance. As a result of these constraints, MR examinations are typically accomplished using multiple volume slabs tailored in orientation and extent to the application and anatomy of interest. Such a tailored volume approach (also referred to as a “targeted volume slab”), in combination with the inherent flexibility and variety of MR pulse sequences, creates a large number of adjustable parameters and a need for careful patient-specific planning.

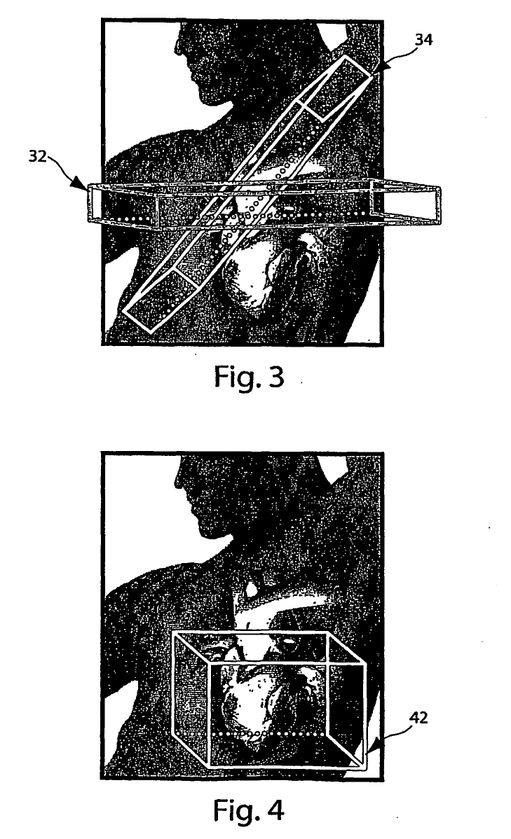

FIG. 3 illustrates a schematic of a targeted volume slab approach used in some previous MRI systems having slower scan rates which thereby make comprehensive volume scanning prohibitive. In the illustration, two target slab volumes 32 and 34, having different orientations are used to gather image data corresponding to the test subject's anatomy in each of the target volumes. For example, in the scan of a test subject's heart, multiple target slabs having different orientations can encompass each coronary artery of interest. In conventional MRI systems, such imaging typically is . performed in a scan time of about 15 to 20 minutes for all three coronary arteries while demanding multiple breath-holds by the test subject. Furthermore, such previous scanning approaches may involve the use of a scout scan (e.g., for alignment purposes) prior to one or more diagnostic scans.

Parallel MRI can circumvent some of the basic constraints on MR imaging speed, and can thereby provide an alternative to the targeted volume slab approach and its associated complexities. Rapid scan rates provided by parallel MRI systems can enable rapid comprehensive volume MR imaging thereby allowing for the acquisition of image data in a comprehensive single volume scan containing all anatomy of interest. Parallel MRI can supplement the field-gradient-based encoding mechanism of traditional MRI by using the sensitivity patterns of RF coils arrayed around the imaging volume. Each coil's localized sensitivity pattern constitutes a distinct view of the imaged object, which may be combined with the spatial modulations produced by gradients to yield a set of projections. Since data is acquired simultaneously in all array elements, multiple projections are available in parallel, and the number of time-consuming gradient steps can be reduced while still preserving full image information.

Rapid comprehensive volume MR imaging, which can be enabled by parallel MRI systems, can allow for single breath-hold scans of anatomy of interest, in contrast to multiple breath-hold scans used in some previous MRI systems that employ targeted volume slab approaches, as described in relation to FIG. 3. For example, FIG. 4 illustrates a schematic of a comprehensive volume MRI imaging approach whereby a scan volume may be used to gather image data for the anatomy of interest, for example the entire heart of the test subject, within the volume 42. Via the use of rapid imaging MRI systems, such comprehensive imaging scans may be performed in a single breath-hold of a test subject. In some embodiments of parallel MRI systems, orders of magnitude acceleration factors may be achieved, thereby making comprehensive volume scans possible within tolerable examination times. Some embodiments of such parallel MRI systems may include a coil array and imaging system having an acceleration factor greater than 2 (e.g., greater than 4, greater 6, greater than 10, greater than 15, greater than 20). In should be understood, that as used herein, a comprehensive imaging volume may have any suitable shape, and is not limited to the rectangular volume illustrated in the schematic of FIG. 4. In some embodiments, a comprehensive volume may be an entire cylindrical volume section of a test subject oriented along the length of the test subject, which may be specified by a start position and an end position along the length of the test subject.

Rapid comprehensive volume MR imaging (e.g., as enabled by the previously described parallel MRI systems) can also allow for a simplified user interface as compared to conventional parameter-oriented MRI imaging interfaces. Such parameter-oriented MRI apparatus interfaces demand that the operator select a number of parameters that specify a precise description of the desired MRI apparatus operation. Examples of such parameters include sequence timing parameters (e.g., echo time, repetition time, flip angle, bandwidth), data acquisition parameters (e.g., acquisition matrix size in frequency- and phase-encoding directions), imaging parameters (e.g., plane selection, 2D or 3D mode), scanning range parameters (e.g., field-of-view, scan thickness, number of slabs), patient position parameters (e.g., patient orientation), and acceleration factor parameters (in the case of parallel MRI systems). As known in the art, in a conventional MRI, parameters are selected by an operator, and a processor (e.g., processor 14 in FIG. 1) controls the MRI apparatus scan based on the inputted parameters. Therefore, when using conventional MRI systems, an operator selects . parameters defining the MRI apparatus operation, rather than by specifying desired diagnostic goals.

Via the use of rapid comprehensive volume MR imaging (e.g., as afforded by parallel MRI), a departure from conventional targeted volume slab approaches allows for the user interface to an MRI system to be greatly simplified using a goal-oriented user interface. In some embodiments, one or more goal-oriented inputs provide a description of desired diagnostic information. The inputted goals may be used by a processor (e.g., processor 14) to determine the parameters that can be used to achieve the desired goals. By specifying diagnostic goals, rather than simply MR imaging parameters, the user interface to the MRI can be greatly simplified. A goal-oriented user interface may be used to specify desired diagnostic goals.

In a further embodiment, a scan prescription can include a scout-free imaging option: Rapid comprehensive volume MR imaging can allow for scout-free imaging, which can reduce test subject scan time and avoid errors. In some embodiments, data processing may be anatomy-specific and/or may include automated multi-plane reconstruction or reformatting of large volume data. This may be contrasted with the targeted volume slab approach wherein the prospective targeted volume slabs are specified in the scan prescription. In some embodiments, rapid comprehensive volume MR imaging allows for simple patient setup including automated coil and isocenter localization.

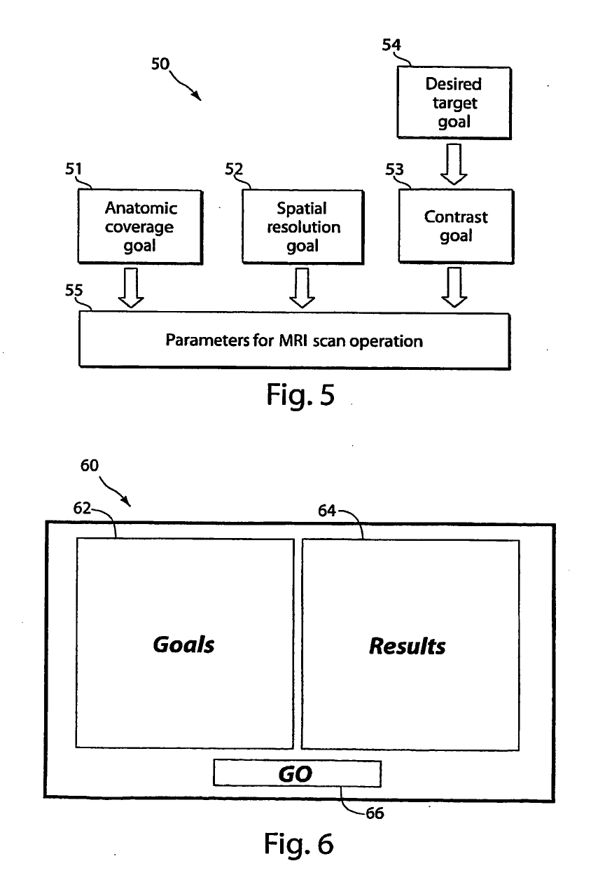

FIG. 5 illustrates a high-level schematic 50 showing a transformation between inputted diagnostic goals and parameters used for controlling the MRI system. A conversion process can be used by a processor (e.g., processor 14) to convent the inputted diagnostic goals 51, 52, 53, and/or 54 to parameters 55 to be used for controlling the MRI system. Goals can include an anatomic coverage goal 51, a spatial resolution goal 52, a contrast goal 53, and/or a desired target goal. The anatomic coverage goal 51 can include a specification of the desired anatomy of interest, for example, the head of a test subject, the torso, one or more limbs, or the entire body. Alternatively or additionally, the anatomic coverage goal 51 may be specified by a specification of by start and end positions along the length of a test subject, wherein the anatomy of interest lies within the comprehensive volume defined by the start and end positions. The spatial resolution goal 52 can include a specification of the desired resolution of the diagnostic image data, which may be related to the size of lesion that may be under diagnosis. For example, a spatial resolution goal may involve the specification of low spatial resolution (e.g., between about 4 mm to 5 mm), medium spatial resolution (e.g., between about 1 mm to 2 mm), or high spatial resolution (e.g., less than 1 mm). The contrast goal 53 can include a specification of contrast mechanisms desired including T1-weighting, T2-weighting, or diffusion weighting. Alternatively, or additionally, a desired target goal 64 may be specified and one or more contrast mechanisms may be determined based on the desired target goal. The desired target goal 54 may be include a specification of the desired target information that is sought, including information about one or more specific tissue types or lesion types. Examples of specific desired target goals may include brain lesions, early strokes, nerve connections, cerebrospinal fluid, to name but a few. A processor can be used to select one or more suitable contrast mechanisms based on the desired target goals. The suitable contrast mechanism(s) for different types of targets is known to those in the art. Parameters 55 for the MRI scan operation can be determined by a processor. A determination of suitable sequence timing parameters may be determined based on the contrast goal(s), as is known to those in the art. For example, T1-weighting contrast may be achieved using short repetition times (e.g., between about 50 to 100 microseconds). Also, scanning range parameters may be determined based on the spatial resolution goal and the anatomic coverage goal.

FIG. 6 illustrates a simplified user interface 60 for an MRI system. The user interface 60 may be displayed on a suitable display, or presented in any other suitable manner. User interface 60 includes a goal-oriented input interface 62, a result-oriented output interface 64, and a start selection interface 66. The goal-oriented input interface to 62 may include selectable options that allow an operator to input specifications of the goals of an imaging process. In some embodiments, the goals may include the desired anatomic coverage, the desired spatial resolution, scan time restrictions (e.g., breath-hold scan, non-breath-hold scan), and/or desired contrast mechanisms. The goals-oriented interface need not necessarily demand the specification of exhaustive parameters that have previously been used for MRI scan prescriptions. The result-oriented output 64 can include an image presentation of acquired MR data. The visual representation can include one or more planar reformat images of acquired volumetric MR data. In some embodiments, the planar reformat of the acquired volumetric data can be tailored to an anatomy of interest of a test subject, where the anatomy of interest of the test subject may be specified via the goal-oriented input interface. In some embodiments, the planar reformat of the acquired data can include volume rendering, maximum intensity projections from one or more view angles, and/or cross-section intensity map images.

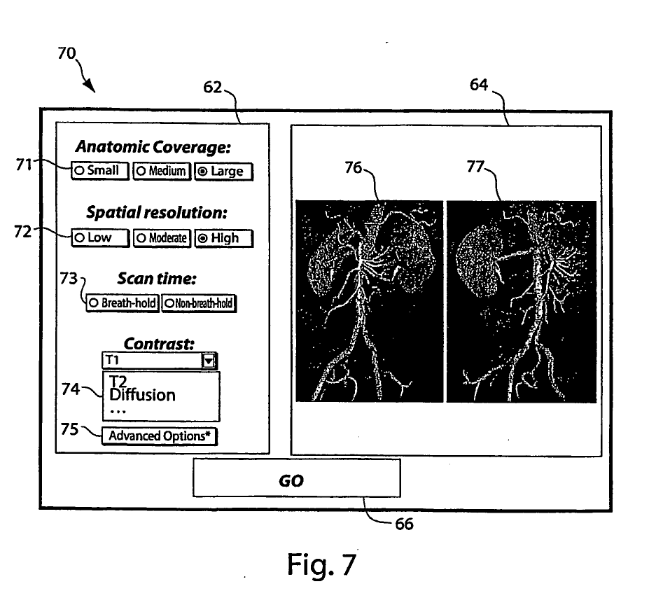

FIG. 7 shows an illustrative embodiment of a user interface 70 for an MRI system. In the illustrative user interface 70, the goal-oriented input interface 62 includes various selections and/or menu interfaces that allow for the specification of the diagnostic goals of the MR scan. Specifically, goal-oriented input interface 62 can include an anatomic coverage selection input interface 71 that enables the selection of the desired diagnostic anatomic coverage. The goal-oriented input interface 62 can include a spatial resolution selection input interface 72 that enables the selection of the spatial resolution of the desired diagnostic image(s). The goal-oriented input interface 62 can include a scan time goal selection input interface 73 that enables the selection of a scan time restriction desired for the examination process. The scan time restrictions may be specified in any suitable manner, for example, the scan time restriction may be specified by a selection of whether the examination should demand that the test subject hold their breath (e.g., breath-hold scans), or that no breath hold is demanded (e.g., non-breath-hold scans). Goal-oriented input interface 62 may include a contrast selection input interface 74 that enables the operator to select the contrast mechanism desired. Examples of contrast mechanisms include T1-weighting, T2-weighting, or diffusion-weighting. Goal-oriented input interface 62 may include an advanced options selection 75 that can enable access to a parameter-oriented input interface (not shown) such as the MR parameter interfaces used in conventional MRI systems, and which may be used to specify specific MR system scan parameters, if the operator chooses to do so.

In the illustrative user interface 70, the result-oriented output interface 64 may include one or more image representations of the acquired MR data. For example, anatomy of interest may be presented from different viewpoints, as shown in image 66 and-image 67, using volume rendering, maximum intensity projections, and/or cross-section intensity maps. In some embodiments, the type of image representation used may be automatically selected by a processor based on defaults that are dependent on the inputted target goals (e.g., tissue types, lesion types). In this way, a standardized presentation of acquired MR data may be automatically provided, as should be compared to some conventional MRI systems where operator know-how is central to the interpretation of acquired data.

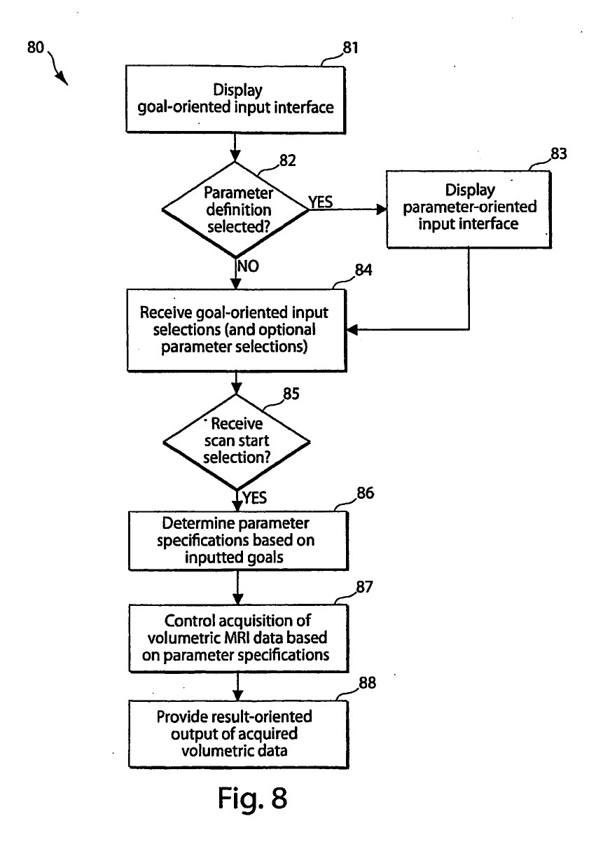

FIG. 8 illustrates a flowchart of a method for use in connection with an MR user interface. The MR user interface may be a user interface such as the interfaces described in FIG. 6, FIG. 7, and/or any other suitable interface. Method 80 may be performed by the MRI system hardware system, a workstation connected to the MRI system, and/or any other system, such as, for example, the MRI system illustrated in FIG. 1.

Method 80 includes the display of a goal-oriented input interface (step 81). The goal-oriented input interface may include input selection options enabling the selection of one or more goals. The goal-oriented input interface may also include an advanced option whereby a parameter definition option enables the display of a parameter-oriented input interface which may be further used to customize the MR scan. A determination is made as to whether the parameter definition option is selected (step 82). If the parameter definition option is selected by the operator, a parameter-oriented input interface is displayed with which the operator may select scan parameters (step 83). Irrespective of whether the advanced parameter-oriented option is selected, the operator may select desired goals using the goal-oriented input interface. The selected goals (and/or optional selected parameters) for the examination are received (step 84). The operator may select a scan start selection to initiate the scan based on the inputted goals (and/or optional selected parameters). An indication that the scan start selection input has been selected may be received (step 85), and the inputted goals (and optional selected parameters) may be used to determine suitable parameter specifications that will enable the diagnostic goals to be achieved (step 86). Volumetric MR data may be acquired based on the determined parameters (step 87), and diagnostic image results may by displayed in a result-oriented output interface (step 88).

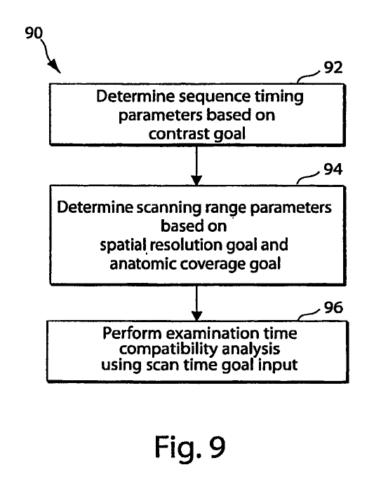

FIG. 9 illustrates a flowchart of a method for determining suitable parameter specifications based on inputted diagnostic goals. The method may be performed using, for example, the MRI system illustrated in FIG. 1. Such a method may be used to perform step 86 of method 80 illustrated in FIG. 8. Method 90 may be performed by the MRI system hardware system, a workstation connected to the MRI system, and/or any other system, as the embodiments are not limited in this respect. The method 90 may involve the determination of suitable sequence timing parameters based on the contrast goal(s), as is known to those in the art (step 92). For example, T1-weighting contrast may be achieved using short echo and repetition times (e.g., echo times (TE) between about 2 and 5 milliseconds, and repetition times (TR) between about 5 and 10 milliseconds). As previously described, alternatively, or additionally, a desired target goal may be specified and one or more suitable contrast mechanisms may be determined based on the desired target goal. The desired target goal may be include a specification of the desired target information that is sought, including information about one or more specific tissue types or lesion types. The suitable contrast mechanism(s) for different types of targets is known to those in the art. Also, scanning range parameters may be determined based on the spatial resolution goal and the anatomic coverage goal (step 94). Furthermore, an examination time compatibility analysis may be performed to determine whether the inputted scan time goal is compatible with the determined parameters (e.g., as deduced based on the inputted goals) (step 96). The examination time compatibility analysis may also involve the selection of a suitable acceleration factor to achieve the desired goals. It should be appreciated that the determined parameters allow for the control of the MRI (e.g., by processor 14) using scanning control methods known to those in the art.

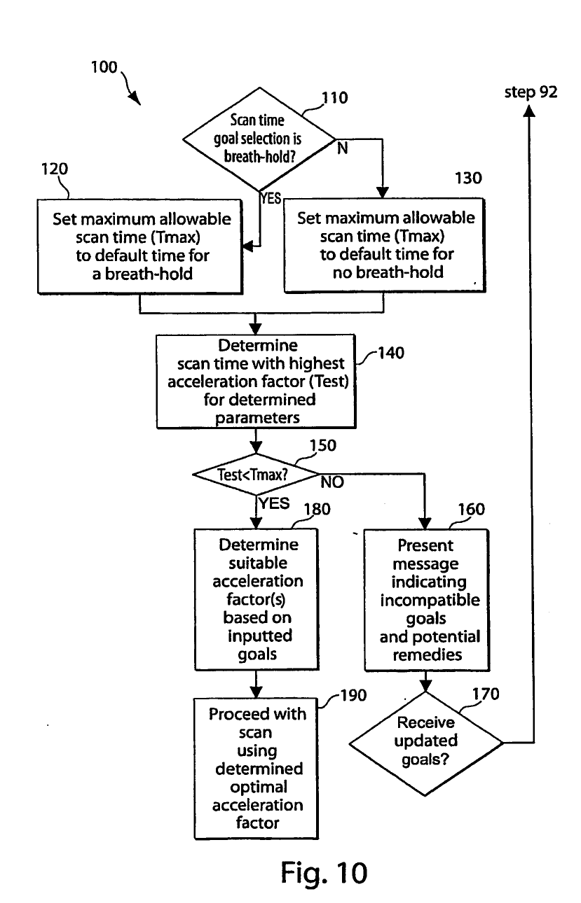

FIG. 10 illustrates a flowchart of a method for performing an examination time restriction compatibility analysis (e.g., step 96 of FIG. 9). The method may be performed using, for example, the MRI system illustrated in FIG. 1. Such an analysis may be performed when a scan time goal was inputted by the MRI system operator. As previously noted, a scan time restriction goal may be specified in any suitable manner, for example, the scan time restriction may be specified by a selection of whether the to examination should demand that the test subject hold their breath (e.g., a breath-hold scan), or that no breath hold is demanded (e.g., a non-breath-hold scan). A default maximum allowable scan time may be associated with a breath-hold and a non-breath-hold scan. For example, a breath-hold may have a default maximum allowable time of 10 seconds, and a non-breath-hold scan may have a default maximum allowable scan time of several minutes. An operator could also specify a specific value for the maximum allowable scan time, thereby over-riding the default values.

Method 100 includes a determination of whether the scan time goal selection is the breath-hold selection (step 110), and if yes, the maximum allowable scan time (Tmax) is set to the default time for a breath hold (step 120), else the maximum allowable scan time (Tmax) is set to the default time for a non-breath-hold (step 130). Based on the highest possible acceleration factor for the MRI system, a calculation is performed to determine the estimated scan time (Test) for the determined scan parameters suitable for the inputted goals (step 140). If the estimated scan time (Test) using the highest acceleration factor is not less than the maximum allowable scan time (Tmax), a message is presented to the operator indicating that the inputted goals are incompatible. The message may also include potential changes to the inputted goals that may remedy the incompatibility (step 160). The operator may change the goals of the scan, updated goals may be received (step 170), and the process may involve looping back to a previous step in the determination of the parameters based on inputted goals. For example, the process my involve looping back to step 92 (or step 94) of method 900.

If it is determined in step 150 that the estimated scan time (Test) using the highest acceleration factor is less than the maximum allowable scan time, a determination of a suitable acceleration factor(s) based on the inputted goals may be performed (step 180). Such a determination may involve a trade-off analysis between signal-to-noise ratio and scan time, since higher acceleration factors are known to decrease the signal-to-noise ratio. If more than one acceleration factor(s) are suitable (e.g., a range of acceleration factors), a message may be presented to enable the operator to select a desired acceleration factor. Alternatively, or additionally, the operator may have selected a desired acceleration factor during the input process prior to initiating a scan request, and in such instances, step 140 may use the selected acceleration factor to determine Test, and step 180 need not necessarily be performed. The scan can proceed using the determined suitable acceleration factor (step 190).

In response to commands inputted through the user interface using, for example, the methods illustrated in FIGS. 8, 9, and 10, the MRI system illustrated in FIG. 1 responds and executes software code to carry out the desired imaging.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings . are by way of example only.

What is claimed is:

1. A method of operating an apparatus for generating a magnetic resonance image, the method comprising:
(a) receiving at least one goal-oriented input;
(b) acquiring volumetric data indicative of a magnetic resonance response in a test subject based on the at least one goal-oriented input; and
(c) providing at least one result-oriented output indicative of the acquired volumetric data.

2. An apparatus for generating a magnetic resonance image, the apparatus comprising:
at least one RF receiving coil;
a controller configured to receive signals from the at least one RF receiving coil to acquire volumetric data indicative of a magnetic resonance response in a test subject based on at least one goal-oriented input; and
a user interface configured to receive the at least one goal-oriented input and provide at least one result-oriented output indicative of the acquired volumetric data.

3. The apparatus of claim 2, wherein the at least one RF receiving coil comprises a plurality of RF receiving coils.

4. The apparatus of claim 2, wherein the controller is configured to have a scout-free mode of operation wherein the acquired volumetric data indicative of the magnetic resonance response is obtained without a pre-scan.

5. The apparatus of claim 2, wherein the acquired volumetric data corresponds to an acquisition volume not tailored to the test subject.

6. The apparatus of claim 3, wherein the plurality of RF receiving coils comprise more than four RF receiving coils.

7. The apparatus of claim 2, wherein the at least one goal-oriented input comprises an anatomic coverage selection.

8. The apparatus of claim 2, wherein the at least one goal-oriented input comprises a spatial resolution selection.

9. The apparatus of claim 2, wherein the at least one goal-oriented input comprises a scan time selection.

10. The apparatus of claim 9, wherein the scan time selection comprises a non-breath hold selection.

11. The apparatus of claim 9, wherein the scan time selection comprises a breath hold selection.

12. The apparatus of claim 2, wherein the at least one goal-orientated input comprises a contrast selection.

13. The apparatus of claim 2, wherein the at least one result-oriented output comprises a visual representation of at least one planar reformat image of the acquired volumetric data.

14. The apparatus of claim 13, wherein the at least one planar reformat of the acquired volumetric data is tailored to an anatomy of interest of the test subject.

15. The apparatus of claim 14, wherein the anatomy of interest of the test subject is specified via the at least one goal-oriented input interface.

16. A user interface for an apparatus for generating a magnetic resonance image, the user interface comprising:
a goal-oriented input interface; and
a result-oriented output interface.

17. The user interface of claim 16, wherein the goal-orientated input interface comprises an anatomic coverage selection input interface.

18. The user interface of claim 16, wherein the goal-orientated input interface comprises a spatial resolution selection input interface.

19. The user interface of claim 16, wherein the goal-orientated input interface comprises a scan time selection input interface.

20. The user interface of claim 19, wherein the scan time selection input interface comprises a non-breath hold selection.

21. The user interface of claim 19, wherein the scan time selection input interface comprises a breath hold selection.

22. The user interface of claim 16, wherein the goal-orientated input interface comprises a contrast selection input interface.

23. The user interface of claim 16, wherein the result-oriented output interface comprises a visual representation of at least one planar reformat image of volumetric data acquired by the apparatus.

24. The user interface of claim 23, wherein the at least one planar reformat of the acquired volumetric data is tailored to an anatomy of interest of a test subject.

25. The user interface of claim 24, wherein the anatomy of interest of the test subject is specified via the goal-oriented input interface.
